(19) United States
(12) Patent Application Publication
(10) Pub. No.: US 2023/0054260 A1
(43) Pub. Date: Feb. 23, 2023

(54) Method and System for Production of Layered CU-Graphene Ultra Conductor Wire

(71) Applicant: ATATURK UNIVERSITESI BILIMSEL ARASTIRMA PROJELERI BIRIMI, Erzurum (TR)

(72) Inventors: Mehmet ERTUGRUL, Erzurum (TR); Ahmet ÖZMEN, Agri (TR); Mohd Nizar HAMIDON, Selangor (MY)

(21) Appl. No.: 17/784,628

(22) PCT Filed: Aug. 18, 2021
(86) PCT No.: PCT/TR2021/050830

§ 371 Date: Jun. 13, 2022

(51) Int. Cl. H01B 1/02; H01B 1/04; H01B 13/00

(52) U.S. Cl. CPC H01B 1/026; H01B 1/04; H01B 13/0026

(57) ABSTRACT

The invention relates to a system for producing Cu-Graphene composite wire that can replace copper cables used in transmission lines, electrical machines, transformers and households, and a method for said production system.

### TECHNICAL FIELD

The invention relates to a system for producing Cu-Graphene composite wire that can replace copper cables used in transmission lines, electrical machines, transformers and households, and a method for said production system.

### Present State of the Art

Conductors are used in energy transmission and transmission lines around the world. The energy need is increasing day by day, and accordingly, the existing conductors are insufficient to meet this need. For this reason, existing conductors are replaced with conductors with larger cross-section that have a higher current carrying capacity than the conductor. This causes time and economic loss. In addition, the need for more energy causes overloading in the cables, leading to heating and therefore the conductors are damaged.

Today, various methods are used to obtain Cu-Graphene composite structure. The mentioned methods cannot be used in the fabrication of conductor cables due to the need for nanoscale production. In addition, since Cu-Graphene composite production methods are not carried out in a single system, the production stages take time and due to the oxidation of the cables, the conductivity decreases and the cables heat up. Therefore, the production of graphene wire is out of question in current applications in the technical field. Although there have been some studies on the production of graphene composites, graphene is in the form of flakes in metal in these studies. In this sense, it is not possible to talk about a continuous graphene structure that surrounds the entire wire.

The patent application document with the publication number KR20140024561 A was determined in the patent and literature search for the state of the art. The document in question relates to a graphene-coated metal conductor and a flexible flat cable containing it. More particularly, the production of a flexible flat cable comprising a graphene-coated metal conductor and said coated metal conductor is disclosed. According to the production system described in the document, production is carried out in multiple stages and for this, it is necessary to feed the system repeatedly.

In conclusion, there are many problems and negativities in the technical field in question, as mentioned above, and existing applications are insufficient in solving these problems and negativities. This necessitates a development and an innovation in the present art.

### BRIEF DESCRIPTION OF THE INVENTION

The present invention relates to a system and method for producing Cu-Graphene composite wire that meets the above-mentioned requirements, eliminates all disadvantages and brings some additional advantages.

The main purpose of the invention is to produce Cu-Graphene composite wire with increased current carrying capacity. By increasing the current carrying capacity, it will be possible to produce devices such as transformers, motors, etc., which provide the same performance and produce less heat by using less wire. In addition, due to its graphene structure, more data transfer will be provided at higher frequencies and wide band range. Thanks to the invention, the current carrying capacity of the Cu-Graphene composite structure has been increased 4 times compared to the copper wire. Therefore, it can be used easily in places where more energy is needed.

Another aim of the invention is to produce a Cu-Graphene composite wire, in which the surface of the wire is covered with a continuous graphene layer, unlike the existing applications. Thus, graphene structures that are layered and surround the wire as a whole in metal are obtained.

Another aim of the invention is to provide coating in the desired number of layers without removing out the wire, contrary to the prior art applications. In the method of the invention, there is an inverted cylindrical magnetron for coating metal at one end of the system and a CVD furnace for coating graphene at the other end thereof. In this way, coating processes are carried out without removing out the wire.

Another aim of the invention is to develop a production system for forming layers with intermediate materials that increase the current carrying capacity of conductors. The production system in question is a production system that coats graphene on the conductor and then coats it with copper again and repeats this process at the desired layer value. In this system, since it will be produced in a conductive vacuum environment, oxidation is prevented. In the technical field, in existing applications, a production technique that grows Graphene on copper wire, produces copper thereon, repeats this process and remains in a vacuum environment during these repetitions has not been encountered.

In the invention, the Chemical Vapor Deposition (CVD) technique is used to coat the graphene, and the Inverted Cylindrical Magnetron technique is used to form the Cu layer. In addition, Silver-Graphene and Aluminum-Graphene composite structures can also be produced by changing the Cu layer forming part in the method of the invention. The Inverted Cylindrical Magnetron technique is used to create Silver layer, and the Thermal Evaporation technique is applied to create Aluminum layer.

Structural features and the characteristics and all the advantages of the invention will be understood more clearly with the detailed description and FIGURES below. For this reason, the evaluation should be made taking into account the relevant detailed description.

### DESCRIPTION OF THE FIGURES FOR A BETTER UNDERSTANDING OF THE INVENTION

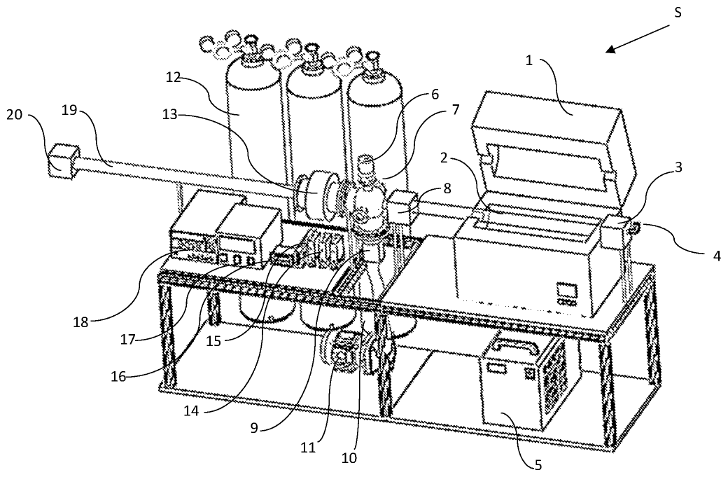

In FIG. 1, the general view of the production system of the invention is given.

### LIST OF THE REFERENCE NUMBERS

S Production system
1 Furnace
2 Glass pipe
3 Head
4 Head connection
5 Cooler
6 Vacuum gauge
7 Vacuum chamber
8 Valve
9 Turbo Molecular Pump (TMP)
10 Vacuum hose
11 Mechanical vacuum pump
12 Gas tube
13 Inverted Cylindrical Magnetron
14 Gas Valve
15 TMP driver
16 Vacuum indicator
17 Gas adjustment unit
18 Power source
19 Arm
20 Conductor puller

### DETAILED DESCRIPTION OF THE INVENTION

In this detailed description, the preferred embodiments of the invention are merely described for a better understanding of the subject matter and without any limiting effect.

The invention relates to a production system (S) for producing Cu-Graphene composite wire and a method for said production system (S). In FIG. 1, the general view of the production system (S) of the invention is given. The production system (S) of the invention includes at least one furnace 1 to form a graphene layer on copper cables. The said furnace (1) can rise to high temperatures and suddenly cool down. There is at least one glass pipe (2) in the center of the furnace (1). The said glass pipe (2), which has the feature of quartz glass, can withstand high temperatures and vacuum can be provided. At least one head (3) is configured to hold the glass pipe (2) in the structure of the said production system (S). In a preferred embodiment of the invention, the said head (3) is located at one end of the glass pipe (2). In addition to its holding function, the head (3) is connected to a cooler (5) by hoses. In this way, it cools the glass pipe (2). The head connections (4), which provide the connection between the cooler (5) and the head (3) for cooling the head (3), are also available in the structure of the production system (S). At the same time, the connection with the gas tubes (12) is provided by the head connections (4). Thus, gas inlet is also provided to the glass pipe (2). In a preferred embodiment of the invention, the head (3) has vacuum and watertight features. There is a head (3) on one end and a Turbo Molecular Pump (TMP) (9) at the other end of the glass pipe (2).

In the production system (S) of the invention, there is at least one vacuum gauge (6), which functions as a sensor measuring the vacuum level of the production system (S). The production system (S) includes at least one vacuum chamber (7) in which the necessary vacuum is provided. The vacuum chamber (7) allows the control of the layered structure, by means of a glass part on its front side. The Turbo Molecular Pump (TMP) (9) is located at the bottom of the said vacuum chamber (7), while the aforementioned vacuum gauge (6) is located at the top thereof. The task of the Turbo Molecular Pump (TMP) (9) is to vacuum the vacuum chamber (7). The production system (S) includes a TMP driver (15) to manage the function of the Turbo Molecular Pump (TMP) (9). The vacuum level of the vacuum chamber (7) is shown by the vacuum indicator (16).

At the same time, the vacuum chamber (7), of which gas inlets are configured at the back side thereof, is connected to the valve (8) on the right side and to the Inverted Cylindrical Magnetron (13) on the left side. The Inverted Cylindrical Magnetron (13) covers the conductors on the cables. This coating can be copper, aluminum or silver. The electrical power required for the Inverted Cylindrical Magnetron (13) is provided by at least one power source (18). In order to form layered structures on the conductor, the movement of the cables is carried out via at least one arm (19). There is at least one conductor puller (20) connected to the said arm (19). By means of the conductor puller, movement is provided to the cable.

The valve (8) is located between the vacuum chamber (7) and the glass pipe (2) and is used to separate the vacuum chamber (7) from the glass pipe (2).

The production system (S) includes at least one mechanical vacuum pump (11) to provide the initial vacuum. A vacuum hose (10) is located between the mechanical vacuum pump (11) and the Turbo Molecular Pump (TMP) (9).

There are gas valves (14) in the structure of the production system (S) in order to open and close the inlet of the gases coming from the gas tubes (12) to the vacuum chamber (7). In this part, the gas adjustment unit (17) is configured to adjust the amount and time of Hydrogen, Nitrogen and Methane gases that will enter the vacuum chamber (7).

In the operational principle of the production system (S) of the invention, firstly, the conductor cable arrives at the glass pipe (2) located in the center of the furnace (1) to form the first layer. Pre-vacuum is provided by the mechanical vacuum pump (11). After the pre-vacuuming process is completed, the Turbo Molecular Pump (TMP) (9) is operated by the TMP driver (15), and accordingly, the vacuum hose (10) located between the mechanical vacuum pump (11) and the Turbo Molecular Pump (TMP) (9) fulfills its function. At these stages, the vacuum value measured by the vacuum gauge (6) is followed by the vacuum indicator (16).

Gas (Hydrogen) is supplied to prevent oxidation in the production system (S). During this process, gas tubes (12) are used with the help of the gas valve (14). At the same time, the furnace (1) is heated to high temperatures (preferably about 1035 C) and the cooler (5) is started when the heating process starts. Depending on the operation of the cooler (5), the head (3), the head connections (4) and the valve (8) are cooled. When the temperature reaches the desired values, carbon-containing gas (methane etc.) is supplied to the production system (S) in the same way. This process is carried out in the desired time, the gas containing carbon is turned off and the furnace (1) is cooled rapidly. With this process, the graphene layer is grown. In the next step, the cooled conductor is brought to the portion of the Inverted Cylindrical Magnetron (13) with the help of the conductor puller (20) and the arm (19). By means of the valve (8), the connection with the furnace (1) is turned off and the desired conductor (copper, silver, aluminum, etc.) is coated on the graphene layer. For the coating process, a gas such as argon etc. is supplied to the system.

After the gas is supplied, the power adjustment is made with the power source (18) and the gas adjustment is made with the gas adjustment unit (17), so that the conductor is covered in the desired thickness. When this process is completed, the power source (18) and a gas such as argon etc. are turned off. By means of this process performed in the vacuum chamber (7), the first layered structure is formed. It is possible to control the process steps with the windshield in the vacuum chamber (7). According to how many layers of composite structure is desired to be formed on the conductor, these processes should be repeated. The completed conductors are removed from the system and a conductor graphene composite structure is formed on the non-layered parts following the conductor.

In order to solve the technical problems mentioned above and to realize all the advantages that can be understood from the detailed description, the present invention relates that a production system (S) to produce Cu-Graphene composite wire comprises;
At least one furnace (1) to form a graphene layer for the cables,
At least one glass pipe (2) in the center of the furnace (1),
At least one head (3) to hold the glass pipe (2),
At least one cooler (5) to cool the glass pipe (2) and the head (3),
The head connections (4) providing the connection between the cooler (5) and the header (3),
At least one vacuum chamber (7) in which the necessary vacuum is provided,
A Turbo Molecular Pump (9) to vacuum the vacuum chamber (7),
A TMP driver (15) to manage the function of the Turbo Molecular Pump (9),
An Inverted Cylindrical Magnetron (13) to cover the conductors on the cables.
At least one power source (18) to provide the necessary electrical power to the Inverted Cylindrical Magnetron (13),
At least one arm (19) to enable the movement of the cables so that the layered structures can be formed on the conductor,
At least one conductor puller (20) which is connected to the arm (19) and moves the said cables,
At least one valve (8) to separate the vacuum chamber (7) and the glass pipe (2),
At least one mechanical vacuum pump (11) to provide the initial vacuum,
A vacuum hose (10) located between the mechanical vacuum pump (11) and the Turbo Molecular Pump (TMP) (9).

1. A production system (S) to produce Cu-Graphene composite wire, characterized in that it comprises;
At least one furnace (1) to form a graphene layer for the cables,
At least one glass pipe (2) in the center of the furnace (1),
At least one head (3) to hold the glass pipe (2),
At least one cooler (5) to cool the glass pipe (2) and the head (3),
The head connections (4) providing the connection between the cooler (5) and the header (3),
At least one vacuum chamber (7) in which the necessary vacuum is provided,
A Turbo Molecular Pump (9) to vacuum the vacuum chamber (7),
A TMP driver (15) to manage the function of the Turbo Molecular Pump (9),
An Inverted Cylindrical Magnetron (13) to cover the conductors on the cables.
At least one power source (18) to provide the necessary electrical power to the Inverted Cylindrical Magnetron (13),
At least one arm (19) to enable the movement of the cables so that the layered structures can be formed on the conductor,
At least one conductor puller (20) which is connected to the arm (19) and moves the said cables,
At least one valve (8) to separate the vacuum chamber (7) and the glass pipe (2),
At least one mechanical vacuum pump (11) to provide the initial vacuum,
A vacuum hose (10) located between the mechanical vacuum pump (11) and the Turbo Molecular Pump (TMP) (9).

2. The production system (S) in accordance with claim 1, characterized in that the production system (S) comprises at least one vacuum gauge (6) that functions as a sensor measuring the vacuum level.

3. The production system (S) in accordance with claim 1, characterized in that the vacuum level of the vacuum chamber (7) is indicated by the vacuum indicator (16).

4. The production system (S) in accordance with claim 1, characterized in that it comprises an Inverted Cylindrical Magnetron (13), which can make copper, aluminum and silver coating.

5. The production system (S) in accordance with claim 1, characterized in that it comprises gas tubes (12) to provide entrance to the vacuum chamber (7).

6. The production system (S) in accordance with claim 5, characterized in that it comprises gas valves (14) to enable the inlet of the gases coming from the gas tubes (12) to be opened and closed.

7. The production system (S) in accordance with claim 6, characterized in that it comprises a gas adjustment unit (17) for adjusting the amount and time of the gases entering the vacuum chamber (7).
